(19) United States
(12) Patent Application Publication
(10) Pub. No.: US 2026/0327092 A1
(43) Pub. Date: Oct. 22, 2026

(54) METHODS FOR RECOVERING ELEMENTS FROM A WASTE MATERIAL

(71) Applicant: Battelle Energy Alliance, LLC, Idaho Falls, ID (US)

(72) Inventors: Qiang Wang, Idaho Falls, ID (US); Robert V. Fox, Idaho Falls, ID (US)

(21) Appl. No.: 19/110,382

(22) PCT Filed: Sep. 12, 2023
(86) PCT No.: PCT/US2023/074002

§ 371 Date: Mar. 10, 2025

Related U.S. Application Data
(60) Provisional application No. 63/375,346, filed on Sep. 12, 2022.

(51) Int. Cl. C01G 53/84; C01D 15/08; C01G 53/42; C22B 26/12; C25C 1/08; H01M 10/54

(52) U.S. Cl. CPC C01G 53/84; C01D 15/08; C01G 53/42; C22B 26/12; C25C 1/08; H01M 10/54; C01P 2002/50; C01P 2004/03; C01P 2006/40

(57) ABSTRACT

A method for recovering elements from a waste material is disclosed, such as a black mass from spent Li-ion batteries, comprising thermally treating a solid waste material comprising carbon, at least one alkali metal, and one or more of a transition metal and a transition metal oxide, dissolving the thermally treated solid waste material in a solvent to form a dissolved waste material solution, removing the at least one alkali metal from the dissolved waste material solution to form an initial leaching solution, leaching the at least one transition metal to form a pre-purified leaching solution, and removing impurities from the pre-purified leaching solution to form a purified leaching solution. Precipitating transition metal particles from the purified leaching solution and forming a mixed metal oxide particle from the recovered lithium and precipitated transition metal particles is also disclosed.

### CROSS-REFERENCE TO RELATED APPLICATIONS

This application is a national phase entry under 35 U.S.C. § 371 of International Patent Application PCT/US2023/074002, filed Sep. 12, 2023, designating the United States of America and published as International Patent Publication WO 2024/059585 A2 on Mar. 21, 2024, which claims the benefit under Article 8 of the Patent Cooperation Treaty of United States Patent Application Serial No. 63/375,346, filed Sep. 12, 2022.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure generally relate to a method for recovering elements from waste materials. In particular, embodiments of the disclosure relate to a method for recovering lithium and transition metals from spent lithium ion batteries.

### BACKGROUND

The consumption of lithium-ion (Li-ion) batteries grows exponentially in the United States and worldwide. The hurdles that hinder industrial scale recovery of spent Li-ion batteries include the absence of both a cost-effective and environmentally sustainable battery handling and recycling process. Conventional recovery technologies include pyrometallurgy, direct recycling, and hydrometallurgy, which technologies may be ineffective cost-wise or environmentally unsustainable. Pyrometallurgy technologies may have high capital costs (high temperature furnace), may be energy intensive, and may emit toxic gases. The pyrometallurgy technologies also rely on hydrometallurgy for further separation of some elements from a mixture containing cobalt (Co), nickel (Ni), copper (Cu), and iron (Fe). Direct recycling uses strict battery sorting, may not remain current with the evolution of cathode formulas in the market, and may not fully restore the material to “like new” function. Even though hydrometallurgy is the least expensive way to recover elements from spent Li-ion batteries, it has drawbacks including high chemical consumption and adverse environmental impact.

Hydrometallurgy involves leaching and extraction of metals in a soluble form to recover the valuable elements. An electrochemical system may be employed to extract metals in such a system. A cathode precursor is a material that contains nickel, manganese, and cobalt (NMC). A cathode, such as for a Li-ion battery, may be prepared by known methods including combining the NMC cathode precursor with lithium. Cobalt, nickel, and manganese in the cathode of the electrochemical system are +3 or +4 valence and have very low solubility in acid. Reductants, such as hydrogen peroxide (H₂O₂), sodium metabisulfite (Na₂S₂O₅), with excessive acid, are added to accelerate the dissolution step. All the commercially valuable elements, including Li⁺, Co²⁺, Ni²⁺ and Mn²⁺ ions, dissolve into the acid together. Precipitation, solvent extraction, electrodeposition, ionic exchange, or a combination of these methods, can be applied to prepare a leaching solution for element separation/recovery from the leaching solution.

The conventional processes may not be suitable for industrial-scale processing. Precipitation methods may use a considerable amount of sodium hydroxide (NaOH) to neutralize excessive acid and remove impurities by increasing the pH to between 6 and 7, and co-precipitating Co, Ni, and manganese (Mn), which may be used as a cathode precursor (nickel manganese cobalt hydroxide (NiₓMn_{y}Co_{z}(OH)₂) particles) for preparing a battery cathode, such as a Li-ion battery cathode, by adding NaOH and chelate ammonium hydroxide (NH₄OH).

However, the residue solution may include additional Na₂SO₄ as an impurity mixed with the leached Li₂SO₄, NH₄OH, and other impurities. Low concentrations of Co²⁺, Ni²⁺ and Mn²⁺ ions may also be present. When re-use of the residue solution, for example, as an NH₄OH resource, is desired in order to synthesize NiₓMn_{y}Co_{z}(OH)₂, the Na⁺, SO₄²⁻ and Li⁺ ions, and other impurities, may have a detrimental effect on the particle size and particle density of NiₓMn_{y}Co_{z}(OH)₂, causing the particle to fail to meet industrial standards. Na⁺ and Li⁺ ions are very difficult to separate from each other as well. The residue solution is typically directly discharged to the environment, causing pollution and wasting Li⁺ ions. Solvent extraction methods have a high environmental impact and are only applied in some areas where environmental regulations are less strict.

Recovering and recycling material from spent waste, such as spent Li-ion batteries, not only reduces the amount of waste, but also produces material suitable for use in preparing new products such as new Li-ion batteries. However, some currently available methods for recovering transition metals from spent Li-ion batteries may introduce impurities, which are mixed with leached lithium sulfate (Li₂SO₄). For example, precipitation may introduce sodium sulfate (Na₂SO₄) mixed with leached Li₂SO₄, and these are very difficult to separate. The residue solution, containing Na₂SO₄, Li₂SO₄, and low concentrations of nickel, cobalt, and manganese, is discharged into the environment, polluting the environment and wasting lithium and ammonium.

### BRIEF SUMMARY

This summary does not identify key features or essential features of the claimed subject matter, nor does it limit the scope of the claimed subject matter.

A method for recovering elements from a waste material is disclosed. The method comprises thermally treating a solid waste material comprising carbon, at least one alkali metal, and one or more of a transition metal and a transition metal oxide, dissolving the thermally treated solid waste material in a solvent to form a dissolved waste material solution, removing the at least one alkali metal from the dissolved waste material solution to form an initial leaching solution, leaching the one or more of the transition metal and transition metal oxide to form a pre-purified leaching solution, and removing impurities from the pre-purified leaching solution to form a purified leaching solution.

A method for recovering elements from one or more of spent lithium ion batteries, ferromanganese slag, and mine tailings is also disclosed. The method comprises calcinating black mass waste material from one or more of spent lithium ion batteries, ferromanganese slag, and mine tailings, the black mass comprising lithium and one or more of a transition metal and a transition metal oxide, dissolving the calcinated black mass in a solvent to form a dissolved waste material solution, removing lithium from the dissolved waste material solution to form an initial leaching solution, leaching the one or more of the transition metal and transition metal oxide to form a pre-purified leaching solution, and removing impurities from the pre-purified leaching solution to form a purified leaching solution.

A method is also disclosed comprising providing a black mass from spent lithium ion batteries, the black mass comprising one or more of lithium transition metal oxide, nickel, manganese, cobalt, nickel oxide, manganese oxide, and cobalt oxide, calcinating the black mass, the calcinated black mass comprising one or more of lithium carbonate, lithium fluoride, nickel, manganese, cobalt, nickel oxide, manganese oxide, and cobalt oxide, contacting the calcinated black mass with water to form a dissolved black mass solution, the dissolved black mass solution comprising one or more of lithium carbonate and lithium fluoride, removing one or more of the lithium carbonate and lithium fluoride from the dissolved black mass solution by adjusting one or more of the black mass solution pH and temperature to form an initial leaching solution comprising one or more of lithium carbonate and lithium fluoride, adding an acid to the one or more of nickel, manganese, cobalt, nickel oxide, manganese oxide, and cobalt oxide, to convert the one or more of nickel, manganese, cobalt, nickel oxide, manganese oxide, and cobalt oxide to nickel sulfate, manganese sulfate, and cobalt sulfate to form a pre-purified leaching solution, removing impurities from the pre-purified leaching solution to form a purified leaching solution; and adding sodium hydroxide, ammonium hydroxide, or a combination thereof to the purified leaching solution to precipitate NiₓMn_{y}Co_{z}(OH)₂ from the purified leaching solution to form a residual solution.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a process flow illustrating a method of recovering elements from a waste material according to embodiments of the disclosure;

FIG. 2 is a process flow illustrating a method of recovering elements from a waste material according to further embodiments of the disclosure;

FIG. 3 is a scanning electron micrograph showing growth at 1 hour of industrial standard NiₓMn_{y}Co_{z}(OH)₂ particles using hydrothermal synthesis;

FIG. 4 is a scanning electron micrograph showing growth at 5 hours of industrial standard NiₓMn_{y}Co_{z}(OH)₂ particles using hydrothermal synthesis; and

FIG. 5 is a scanning electron micrograph showing growth at 24 hours of industrial standard NiₓMn_{y}Co_{z}(OH)₂ particles using hydrothermal synthesis.

### DETAILED DESCRIPTION

Methods of recycling a waste material are disclosed. The methods are used to separate elements and chemicals, remove impurities, and recover valuable elements and chemicals that may be recycled into new products or processes such as new Li-ion batteries. The methods may also mitigate or eliminate the issue of waste emission, particularly for industrial scale recycling. In some embodiments, removing and recovering elements (e.g., chemical elements) of interest (e.g., lithium and one or more transition metals and/or one or more transition metal oxides) from a waste Li-ion battery material are disclosed. The elements of interest may be present as chemical compounds that are removed from the waste material and reused. The method may include providing a solid waste material containing at least one alkali metal and one or more additional chemical element(s) of interest (e.g., one or more transition metals such as nickel, cobalt, and manganese and/or or more transition metal oxides such as nickel oxide, cobalt oxide, and manganese oxide); thermally treating the solid waste material; dissolving the thermally treated solid waste material in a first solution (e.g., initial solution) to form a second solution (e.g., dissolved waste material solution) containing the at least one alkali metal, and one or more impurities; and recovering the at least one alkali metal, such as lithium (in the form of a lithium compound, such as lithium carbonate) from the dissolved waste material solution to form a third solution (e.g., initial leaching solution) containing the at least one alkali metal and one or more impurities. Recovering the at least one alkali metal may comprise adjusting one or more of the pH and temperature of the dissolved waste material solution. The one or more transition metals are substantially insoluble. Substantially no transition metal is dissolved into the dissolved waste material solution. The method may include adding an acid to the one or more transition metals and/or transition metal oxides remaining in the solid waste after recovering the alkali metal, to convert one or more of the transition metals and/or transition metal oxides into a transition metal sulfate; and forming a fourth solution (e.g., pre-purified leaching solution) containing the transition metal sulfate and one or more impurities. The method may include removing impurities (e.g., one or more of hydrogen sulfate, iron sulfate, aluminum sulfate, and copper sulfate) from the pre-purified leaching solution to form a fifth solution (purified leaching solution) and precipitating transition metals (e.g., nickel, cobalt, and/or manganese) from the purified leaching solution to form a sixth solution (e.g., a residual solution). The method may further include forming mixed metal oxides from the recovered at least one alkali metal and the precipitated transition metal. The method may further include using the mixed metal oxide in a new product or process. The residual solution may contain sodium hydroxide, sodium sulfate, ammonium hydroxide, and traces of cobalt sulfate, nickel sulfate, and manganese sulfate. The method may further include reusing the residual solution in another process of removing impurities from a pre-purified leaching solution. The method may further include separating sodium sulfate from the residual solution and reusing the sodium sulfate in another process, such as another process of removing impurities from a pre-purified leaching solution. The method may further include crystalizing the sodium sulfate from the residual solution (e.g., by adjusting the temperature of the residual solution) forming a desalinated residual solution and using the crystalized sodium sulfate to remove impurities from the pre-purified leaching solution (e.g., reusing the crystalized sodium sulfate in an electrochemical membrane reactor used for purifying the pre-purified leaching solution). The method may further include using the desalinated residual solution as an ammonium hydroxide resource (e.g., for precipitating transition metals from the purified leaching solution). The method may further include using hydrogen sulfate recovered from the pre-purified leaching solution in another leaching step. Thus, the method includes converting the solid waste material into a usable solution that includes the chemical element(s) of interest, such as lithium, one or more transition metals, one or more transition metal oxides, and impurities. The lithium may be recovered as a lithium compound (such as lithium carbonate (Li₂CO₃)) and the chemical element(s) of interest may be recovered as chemical compound(s), such as transition metal compound(s). The transition metal compound(s) may be precipitated (e.g., selectively precipitated) following the addition of an acid or a base. The chemical compound(s) may be reacted to form a mixed metal oxide product that may be used in additional products or processes. The methods enable recovery of all or substantially all of the chemical elements from the waste material. The methods according to embodiments of the disclosure may significantly reduce or substantially eliminate wastewater emission as compared to conventional methods, thus enabling large scale recovery and recycling of the chemical elements of interest from the waste material, particularly in locations having strict environmental regulations. The method may, for example, be used for recovering commercially valuable elements from spent Li-ion batteries, mine tailings, such as mine tailings from a cobalt and/or nickel mine, ferromanganese slag from ferromanganese alloy manufacturing, or other spent material and using (e.g., recycling) the recovered elements in additional products or processes.

The method may be used by Li-ion battery recyclers, cathode material producers, and Li-ion battery manufacturers, among others. Current hydrometallurgies, such as precipitation, solvent extraction, electrodeposition, ionic exchange, or a combination of these methods, may have high chemical consumption and/or high negative environmental impact. In some embodiments, the method described herein provides for the recovery of substantially all of the valuable elements from a waste mass including lithium, cobalt, nickel and manganese, uses a limited amount of chemicals, re-uses all, or substantially all, of the by-products from the method, and generates essentially zero waste emission.

The method may include recovering an alkali metal from a waste material containing at least one alkali metal and one or more of at least one transition metal and at least one transition metal oxide, removing (e.g., leaching) the transition metal(s) (e.g., by adding hydrogen sulfate to convert the one or more transitional metals or transition metal oxides (e.g., Ni, Co, Mn, NiO, CoO, and/or MnO) to a transition metal sulfate (e.g., NiSO₄, MnSO₄, and/or CoSO₄)), removing impurities, and precipitating nickel, cobalt, and/or manganese. The method includes recovering one or more of the alkali metal(s), transition metals, and transition metal oxide(s) from the waste material, such as one or more of a lithium compound, cobalt, nickel, manganese, cobalt oxide, nickel oxide, and manganese oxide, which may be used as a starting material for a new product or process. The recovered transition metals and transition metal oxide(s) may be reacted (e.g., cosintered) to form a mixed metal oxide that includes the one or more transition metals. The method may further include using one or more of the compounds (e.g., sodium hydroxide, ammonium hydroxide, sodium sulfate) remaining in the residual solution in further processes, such as recycling processes. Therefore, the method according to embodiments of the disclosure may generate substantially no waste, such as substantially zero waste.

The method may include providing a waste material including lithium and one or more transition metals, removing the lithium from the waste mass before removing the transition metal compounds, leaching the transition metal compounds, and removing impurities. The impurities may be removed electrochemically, such as by using an electrochemical membrane reactor. The waste material may be heated (e.g., calcined, oxidized) before removing the lithium, leaching the transition metal compounds, purifying the leached solution containing the transition metal compounds, removing the transition metal compounds from the purified leaching solution leaving a residual solution, and removing the impurities (e.g., removing sodium sulfate) from the residual solution. The transition metals may be removed by adjusting one or more process conditions, such as one or more of temperature, pH, the ratio of ammonium to transition metals, chemical flow rate, stirring, or other process conditions. The chemical composition of the purified leaching solution thus provided may be substantially pure and impurity-free, similar to a chemical composition of a solution prepared from commercially available reagents. Components remaining in the residual solution may be recovered and reused as reagents in the process.

For example, black mass from spent Li-ion batteries is a solid waste material that may contain a mixture of metals including lithium, manganese, cobalt, and nickel. The metals may be present in the black mass in the form of an oxide (e.g., LiNiₓMn_{y}Co_{z}O₂). The black mass may be calcinated, such as in an inert atmosphere, such as in an N₂ or an argon atmosphere. The calcinated black mass may include, but is not limited to, lithium carbonate (Li₂CO₃), lithium fluoride, nickel (Ni), manganese (Mn), cobalt (Co), nickel oxide (NiO), manganese oxide (MnO), and/or cobalt oxide (CoO). When the calcination temperature is high, the calcinated black mass may comprise one or more of the transition metals. For example, when the calcination temperature is high, such as greater than about 550° C., the calcinated black mass may contain one or more of Ni, Mn, and Co. Lithium may be recovered by dissolving the calcinated black mass in a solvent, such as water, in embodiments, weakly acidic water having a pH of from about 1 to about 6, and adjusting the water temperature, the pH, or a combination thereof, to remove (e.g., precipitate) the lithium in the form of a lithium compound, such as lithium carbonate (Li₂CO₃) which is soluble in water. In embodiments, dissolving the calcinated black mass in a solvent may be done at a temperature in the range of from about 10° C. to about −20° C., or from about 10° C. to about −2° C., or at about 0 °C. The transition metals and their oxides, such as Ni, Co, Mn, NiO, CoO, and MnO, of the calcinated black mass, may be substantially insoluble in the solvent. Therefore, the insoluble transition metals and metal oxides, such as Ni, Co, Mn, NiO, CoO, and MnO, remain as solids in the remaining calcinated black mass (that is, are not removed with the soluble lithium compound(s)). The remaining solid(s) comprising one or more of Ni, Co, Mn, NiO, CoO, and MnO, may be leached forming a pre-purified leaching solution. Leaching may comprise adding an acid to the remaining solid.

For example, an acid (e.g., H₂SO₄) may be added to the remaining solid, converting the one or more of Ni, Co, Mn, NiO, CoO, and MnO to NiSO₄, MnSO₄, CoSO₄ and H₂O and forming a pre-purified leaching solution. Impurities may be removed from the pre-purified leaching solution, such as by using an electrochemical membrane reactor, forming a purified leaching solution. A base, such as one or more of ammonium hydroxide (NH₄OH) and NaOH, may be added to the purified leaching solution to co-precipitate nickel, manganese, and cobalt to form a mixed metal oxide, such as NiₓMn_{y}Co_{z}(OH)₂ (NMC), wherein x is 1, y, is 1 and z is 1. However, other values of x, y, and z are possible. The remaining residual solution may include NH₄OH, Na₂SO₄, and a low (e.g., trace) concentration of NiSO₄, MnSO₄, and CoSO₄. The NiSO₄, MnSO₄, and CoSO₄ may be present at a concentration of less than or equal to about 1 part per million (ppm). One or more of components of the residue solution may be recovered and reused in the process.

The following description provides specific details, such as material compositions and processing conditions in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components are inherently disclosed herein and that adding various conventional process components and acts would be in accord with the disclosure.

In addition, the drawings accompanying the disclosure are for illustrative purposes only, and are not meant to be actual views of any particular material, device, or system. Thus, the drawings are not necessarily to scale. The drawings presented in this disclosure are merely idealized representations employed to describe illustrative embodiments.

As used herein, the singular forms “a,” “an,” and “the” are intended to include the plural forms as well, unless the context clearly indicates otherwise.

As used herein, the term “about” in reference to a given parameter is inclusive of the stated value and has the meaning dictated by the context (e.g., it includes the degree of error associated with measurement of the given parameter).

As used herein, “and/or” includes any and all combinations of one or more of the associated listed items.

As used herein, the term “configured” refers to a size, shape, material composition, material distribution, and arrangement of one or more of at least one structure and at least one apparatus facilitating operation of one or more of the structure and the apparatus in a pre-determined way.

As used herein the term “electrolyte” means and includes an ionic conductor, which can be in a solid state, a liquid state, or a gas state (e.g., plasma).

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein).

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

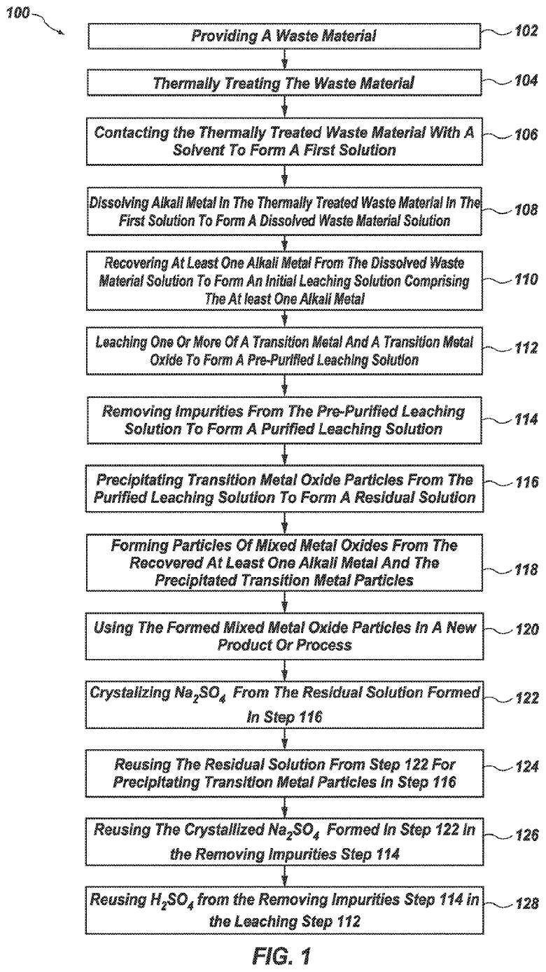

An embodiment of the disclosure will now be described with reference to FIG. 1, which shows a process flow (also termed a “flowsheet”) of the method for recovering chemical compounds (e.g., metal compounds) and removing impurities from a waste material.

The method 100 includes the steps of providing a waste material 102, which may be a solid material containing one or more alkali metals and one or more transition metals to be recovered along with one or more impurities. The method includes thermally treating (e.g., calcinating; e.g., calcinating in an inert atmosphere, such as an N₂ or argon atmosphere) the waste material 104. Thermally treating the waste material converts the alkali metal into a compound that is solvent soluble, such as a water soluble compound, while compounds of the transition metals remain substantially insoluble. For example, calcinating nickel manganese cobalt oxide (LiNiₓMn_{y}Co_{z}O)₂ may decompose the LiNiₓMn_{y}Co_{z}O₂, forming lithium carbonate (Li₂CO₃), nickel (Ni), manganese (Mn), cobalt (Co), nickel oxide (NiO), manganese oxide (MnO), and cobalt oxide (CoO). Li₂CO₃ is soluble in water while Ni, Mn, Co, NiO, MnO, and CoO are substantially insoluble in water. The method includes contacting the thermally treated waste material with a solvent to form a first solution (e.g., initial solution) 106, and dissolving the alkali metal in the thermally treated waste material in the first solution to form a second solution (e.g., dissolved waste material solution) 108. The solvent may be water, weakly acidic water, such as water having a pH of from about 1 to about 6, an alcohol, other solvent, or a combination thereof, in which one or more components of the thermally treated spent material is substantially soluble. Dissolving the thermally treated waste material may include adjusting one or more of the pH and temperature.

The method includes recovering (removing) at least one alkali metal from the dissolved waste material solution to form a third solution (e.g., initial leaching solution) 110.

Recovering the at least one alkali metal may comprise adjusting one or more of pH and temperature of the dissolved waste material solution. The initial leaching solution may substantially contain the one or more recovered alkali metals. The initial leaching solution may be re-used to dissolve alkali metal from another thermally treated waste material. The remaining solid waste may contain the one or more transition metals and transition metal oxides (e.g., nickel, manganese, cobalt, nickel oxide, manganese oxide, and/or cobalt oxide). The method includes recovering the one or more transition metals and transition metal oxides, for example, by leaching the one or more transition metals and transition metal oxides, such as by adding an acid. The acid may, for example, be hydrogen sulfate. The acid may convert the at least one transition metal and/or at least one transition metal oxide to a transition metal sulfate, forming a fourth solution (e.g., pre-purified leaching solution) 112 containing one or more of nickel sulfate, manganese sulfate, and/or cobalt sulfate, water, and impurities, and removing impurities from the pre-purified leaching solution to form a fifth solution (e.g., purified leaching solution) 114.

In embodiments, the first solution (initial solution) comprises water and recovering (removing) lithium from the dissolved waste material solution comprises adjusting a pH of the dissolved waste material solution to a pH of from about 2 to about 14. In embodiments, the first solution (initial solution) comprises water and the pH of the dissolved waste material solution is adjusted to a pH of about 1 to about 6, such as to a pH of about 2. In embodiments, recovering lithium from the dissolved waste material solution comprising adjusting a temperature of the dissolved waste material solution, such as to a temperature in a range of from about 0° C. to about 100° C.

In embodiments, leaching the one or more transition metals and transition metal oxides comprises adding an acid to the one or more transition metals and transition metal oxides. In embodiments, the acid comprises H₂SO₄, HCl, HNO₃, or a combination thereof.

Removing impurities from the pre-purified leaching solution may be accomplished by any suitable or desired method. For example, impurities, such as iron, aluminum, zirconium, and/or chromium, may be precipitated out of the pre-purified leaching solution by conventional methods. In specific embodiments, removing impurities from the fourth solution is accomplished using an electrochemical membrane reactor. In embodiments, the electrochemical membrane reactor may be as described in WO2022/236283, which is hereby incorporated by reference herein in its entirety. For instance, copper, iron, aluminum, zirconium, chromium, or a combination thereof may be electrochemically removed. For example, the electrochemical membrane reactor may be utilized to electroplate copper. The pH may be increased to precipitate one or more of iron, aluminum, zirconium, and chromium. After removal, the impurities may be present in the fifth solution (purified leaching solution) at less than or equal to about 5 ppm. The electrochemical removal does not introduce additional impurities to the fourth solution (pre-purified leaching solution) and consumes only electricity, air, and water.

The method further comprises precipitating transition metals and/or transition metal oxides (e.g., particles of the transition metals and/or transition metal oxides) from the purified leaching solution and forming a sixth solution (residual solution) (also termed “residue solution”) solution 116. The residual solution may contain, for example, ammonium hydroxide, sodium hydroxide, sodium sulfate, and trace amounts of CoSO₄, NiSO₄, and/or MnSO₄. The method may further include forming particles of mixed metal oxides from the recovered at least one alkali metal and the precipitated transition metal particles 118.

The transition metal particles may comprise any transition metal present in the waste material being recycled. For example, the transition metal particles may comprise scandium, titanium, vanadium, chromium, manganese, iron, cobalt, nickel, copper, zinc, rubidium, magnesium, sodium, potassium, cesium, zirconium, niobium, technetium, ruthenium, cadmium, or a combination thereof. In embodiments, the transition metal particles comprise nickel, manganese, cobalt, nickel oxide, manganese oxide, cobalt oxide, or a combination thereof.

The alkali metal in the waste/spent material being recycled may be any suitable or desired alkali metal including lithium, sodium, potassium, rubidium, cesium, or a combination thereof. In specific embodiments, the alkali metal is lithium.

The process herein can comprise forming a mixed metal oxide from the recovered alkali metal and the precipitated transition metals, such as particles of the mixed metal oxide. In embodiments, the particles of the mixed metal oxide include lithium, nickel, manganese, cobalt, or a combination thereof. The method may further comprise using the mixed metal oxide in a new product or process 120. The mixed metal oxide may be used, for example, to produce a battery grade cathode material, such as LiMn_{0.33}Ni_{0.33}Co_{0.33}O₂, LiNi_{0.6}Co_{0.2}Mn_{0.2}O₂, or LiNi_{0.8}Co_{0.1}Mn_{0.1}O₂, for Li-ion batteries.

The method may further comprise removing and reusing components in the residual solution(s), such as Na₂SO₄ and H₂SO₄. The method may further comprise the step 122 of crystalizing Na₂SO₄ from the residual solution. Crystalizing the Na₂SO₄ may include adjusting the temperature of the residual solution to crystalize the Na₂SO₄. The residual solution may then be considered a desalinated residual solution. The method may further comprise reusing the crystallized Na₂SO₄ 126 for removing impurities from the pre-purified leaching solution to form a purified leaching solution. The method may include reusing the desalinated residual solution (obtained by crystalizing Na₂SO₄ 122 from the residual solution) 124 for precipitating transition metal particles 116. The method may further comprise reusing H₂SO₄ 128 for leaching the at least one transition metal oxide in the leaching step 112.

In addition to removing and reusing Na₂SO₄ and H₂SO4, the method according to embodiments of the disclosure also includes removing impurities and reusing the impurities in various acts of the process, such as recycling residual solutions and/or materials crystalized or otherwise removed from the residual solutions during the process. The impurities removed and reused may comprise copper, iron, aluminum, zirconium, chromium, and combinations thereof. There may be excess acid (e.g., excess H₂SO₄) from leaching the at least one transition metal with an acid. The excess acid may be removed (e.g., by removing impurities from the pre-purified leaching solution). The method may include using excess acid remaining after removing impurities from the pre-purified leaching solution and reusing the excess acid such as for leaching the at least one transition metal oxide. The method may also include recovering sodium sulfate from the purified leaching solution and using the recovered sodium sulfate for removing impurities from the pre-purified leaching solution, such as using the recovered sodium sulfate in an electrochemical membrane reactor. The method may also include using the residual solution that may contain sodium hydroxide (NaOH) and/or ammonium hydroxide (NH₄OH) as an NaOH and/or NH₄OH source for a new product or process, such as for the precipitation of transition metal particles from the purified leaching solution, in embodiments, for the precipitation of nickel, manganese, cobalt, or a combination thereof, from the purified leaching solution. Thus, the NaOH and NH₄OH may be recovered and reused during the process. For example, the desalinated residual solution may be used as an ammonium hydroxide resource for co-precipitation of NiₓMn_{y}Co_{z}(OH)₂ particles.

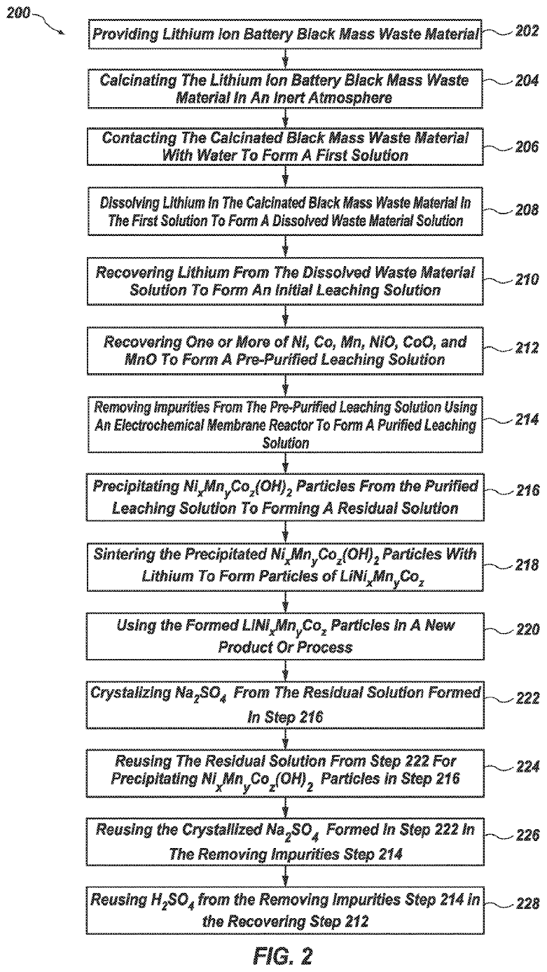

FIG. 2 shows a flow diagram of an embodiment of the present method directed to recovering elements from a spent Li-ion battery. Li-ion batteries are composed of metals including lithium, manganese, cobalt, and nickel. Once a Li-ion battery reaches the end of its useful life, the battery may be collected, dismantled, and shredded. The shredded material may then be processed to produce so-called “black mass,” which may include one or more of carbon, sodium chloride, lithium (e.g., lithium metal oxide), nickel, manganese, cobalt, nickel oxide, manganese oxide, cobalt oxide, copper, aluminum, and iron. For example, the black mass to be recycled from the Li-ion battery may comprise lithium, nickel, manganese, and cobalt in the form of lithium nickel manganese cobalt oxide, such as LiNiₓMn_{y}Co_{z}O₂.

The method 200 includes the steps of providing spent Li-ion battery black mass waste material 202 containing lithium nickel manganese cobalt oxide (LiNiₓMn_{y}Co_{z}O)₂ and calcinating the Li-ion battery black mass in an inert atmosphere, for example, a N₂ or argon atmosphere, 204. Calcinating nickel manganese cobalt oxide (LiNiₓMn_{y}Co_{z}O)₂ may decompose the LiNiₓMn_{y}Co_{z}O₂ forming one or more of lithium carbonate (Li₂CO₃), lithium fluoride, nickel (Ni), manganese (Mn), cobalt (Co), nickel oxide (NiO), manganese oxide (MnO), and cobalt oxide (CoO). Li₂CO₃ is soluble in water while Ni, Mn, Co, NiO, MnO, and CoO are substantially insoluble in water including being substantially insoluble in weakly acidic water.

The method includes contacting the calcinated black mass with water, forming a first solution (initial solution) 206 and dissolving the calcinated black mass in the water (e.g., weakly acidic water) to form a second solution 208 (dissolved waste material solution). The dissolved waste material solution 208 may contain lithium in the form of one or more of soluble lithium carbonate (Li₂CO₃), lithium hydrogen carbonate (LiHCO₃), lithium fluorine, may contain sodium chloride. The one or more of the substantially insoluble nickel, manganese, cobalt, nickel oxide, manganese oxide, and/or cobalt oxide from the calcinated black mass remain solid and do not dissolve in the first solution 206. The method includes recovering the dissolved lithium carbonate from the dissolved waste material solution (e.g., by adjusting one or more of solution temperature and pH) to form a third solution (initial leaching solution) 210. The initial leaching solution may comprise lithium in the form of one or more of soluble lithium carbonate (Li₂CO₃), lithium hydrogen carbonate (LiHCO₃), lithium fluorine, and may contain sodium chloride. The remaining calcinated black mass may comprise one or more of the substantially insoluble nickel, manganese, cobalt, nickel oxide, manganese oxide, and/or cobalt oxide. The method includes recovering, in embodiments, leaching, the insoluble transition metals and/or transition metal oxides, such as one or more of Ni, Co, Mn, NiO, CoO, MnO, and impurities by adding an acid (e.g., hydrogen sulfate) to the one or more of Ni, Co, Mn, NiO, CoO, MnO, to form a fourth solution (e.g., pre-purified leaching solution) 212. The acid added to the initial leaching solution may convert the Ni, Co, Mn, NiO, CoO, and/or MnO to nickel sulfate (NiSO₄), cobalt sulfate (CoSO₄), and/or manganese sulfate (MnSO₄), forming the pre-purified leaching solution containing nickel sulfate, manganese sulfate, cobalt sulfate, water, and impurities. The method includes removing impurities from the pre-purified leaching solution using an electrochemical membrane reactor, to form a fifth solution (e.g., purified leaching solution) 214.

The method further comprises precipitating the elements, such as precipitating one or more compounds including the elements. In some embodiments, the elements are precipitated as particles. However, the elements may be precipitated in other forms. For example, the method may further comprise precipitating mixed metal oxide particles, such as precipitating NiₓMn_{y}Co_{z}(OH)₂ particles, from the purified leaching solution, forming a sixth solution (e.g., residual solution) 216. The residual solution may contain, for example, one or more of ammonium hydroxide, sodium hydroxide, sodium sulfate, and trace amounts of CoSO₄, NiSO₄, and/or MnSO₄.

The method further comprises sintering the precipitated particles to form sintered particles of the mixed metal oxide. In some embodiments, the NiₓMn_{y}Co_{z}(OH)₂ is sintered with lithium to form particles of LiNiₓMn_{y}Co_{z} 218. The method further comprises using the sintered particles, such as the LiNiₓMn_{y}Co_{z} particles, in a new product or process 220. For instance, the LiNiₓMn_{y}Co_{z} particles may be used to form a cathode. The cathode may be formed from the LiNiₓMn_{y}Co_{z} particles by conventional techniques. The method further comprises reusing the residual solution (that is, the residual solution formed in step 216). The residual solution may contain one or more of sodium hydroxide, ammonium hydroxide, and sodium sulfate, which may be reused, such as for the precipitation of particles from the purified leaching solution. The method further comprises crystalizing Na₂SO₄ 222 from the residual solution (formed in step 216). The residual solution may now be considered a desalinated residual solution. The method further comprises using the crystallized Na₂SO₄ 226 (formed in step 222) for removing impurities from the pre-purified leaching solution 212, in embodiments, using the crystallized Na₂SO₄ in the electrochemical membrane reactor. The method further comprises reusing the desalinated residual solution 224 for precipitating NiₓMn_{y}Co_{z}(OH)₂ particles in step 216. The method further comprises reusing H₂SO₄ 228 from the removing impurities in step 214 as the acid for leaching one or more of Ni, Co, Mn, NiO, CoO, MnO in step 212. Thus, the Na₂SO₄ and H₂SO₄ may be recovered and reused during the process.

In embodiments, the method herein includes converting the residual solution into a usable solution. For example, the method may include recovering Na₂SO₄ from the residual solution. A concentration of Na₂SO₄ in the residual solution may be reduced to less than about 1 mol·1⁻¹, by decreasing the residual solution temperature, in embodiments, by decreasing the temperature of the residual solution to a temperature in a range of from about 10° C. to about −20° C., or from about 10° C. to about −2° C., or from about 5° C. to about −2° C., or to about 0° C., and crystallizing Na₂SO₄ from the residual solution. The residual solution with the low concentration of Na₂SO₄ (<1 mol·1⁻¹) can be reused as an NH₄OH source to synthesize NiₓMn_{y}Co_{z}(OH)₂ without impacting particle morphology.

In embodiments, the method includes recovering lithium before leaching. If lithium is not recovered before leaching, it may stay inside the residual solution with a concentration as high as about 2.6 mol·1⁻¹ (lithium sulfate (Li₂SO₄) solubility: 34.9 g/ 100 mL (25° C.) and 29.2 g/100 mL (100 ° C.)). When reusing the residual solution for the next co-precipitation, a high concentration of Li₂SO₄ may work with Na₂SO₄ and adversely affect the morphology of NiₓMn_{y}Co_{z}(OH)₂ particles. The method may significantly reduce the Li₂SO₄ concentration, which affects the co-precipitation of nickel, manganese, and cobalt, by calcinating the black mass and conducting water washing to recover the lithium before leaching. In embodiments, the electrochemical membrane reactor removes impurity from the leaching solution, generating H₂SO₄ by-product, which can be reused for another leaching step. The recovered Na₂SO₄ from the coprecipitation can be reused as an electrolysis salt for the electrochemical membrane. Thus, the method recovers all, or substantially all, of the valuable elements, including Li, Co, Ni and Mn, reuses all, or substantially all, of the by-products, and generates essentially zero waste.

During calcination, the valences of Ni, Mn, and Co are reduced, and lithium is released from the Li-ion battery black mass, forming Li₂CO₃. The Li₂CO₃ is separated from the one or more of Ni, Mn, Co, NiO, MnO, and CoO by a water washing. In embodiments, removing lithium from the dissolved waste material solution comprises adjusting a pH of the dissolved waste material solution, for example, adjusting to a pH of from about 2 to about 14, or from about 1 to about 7. In some embodiments, the pH of the water is adjusted to be weakly acidic, such as in a range of from about 1 to about 6. In certain embodiments, the pH of the water is adjusted to a pH of about 2. The Li₂CO₃ may be converted to LiHCO 3, which has a higher solubility in water than Li₂CO₃. Ni, Mn, Co, NiO, MnO, and CoO are not substantially soluble and therefore, are not dissolved in the weak acid. The water washing step may also remove other impurities, such as PO₄³⁻ ions and organic solvent, from Ni, Co, and Mn oxides.

After leaching the insoluble transition metals and transition metal oxides, the leaching solution may be purified, in embodiments, by using an electrochemical membrane reactor. During purification, substantially all of the excessive H₂SO₄ is removed from the leaching solution, forming a purified leaching solution. Thus, the relative concentration of the Ni, Co, and Mn in the purified leaching solution is increased. The Ni, Co, and Mn oxides are then co-precipitated by any suitable or desired method, such as by utilizing a reactor.

In embodiments, after the co-precipitation, the residual solution may contain about 0.335 mol/L Na₂SO₄, from about 0.5 to 1 mol/L NH₄OH, and trace amounts of Ni, Co, and Mn. The residual solution is essentially free of, that is, does not contain, Li+ions, PO₄³⁻ ions, or organic solvent. The temperature of the residual solution may be lowered to crystalize Na₂SO₄. In embodiments, the temperature of the residual solution may be reduced to a temperature in a range of from about 10° C. to about −20 ° C., or from about 10° C. to about −2° C., or from about 5° C. to about −2° C., or to about 0° C., to crystalize a portion of the Na₂SO₄. The solubility of Na₂SO₄ is about 0.335 mol/L in 0° C. water. The residual solution may then contain about 0.335 mol/L Na₂SO₄, about 1 mol/L NH₄OH, and a trace amount of Ni, Co, and Mn.

Having a concentration of about 0.335 mol/L Na₂SO₄ may not adversely affect the synthesis of industrial standard NMC (nickel cobalt manganese) cathode precursor. Thus, the residual solution prepared in accordance with embodiments of the disclosure may be utilized as a source of NH₄OH resource for co-precipitating NMC cathode precursor.

The presence of Na₂SO₄ impurity may influence the crystallization of nickel, cobalt, and manganese precursor. Particle tap density is the ratio of the mass of the powder to the volume occupied by the powder after it has been tapped for a defined period of time. The tapped density of a powder represents its random dense packing. Tapped density can be calculated using the equation g/mL=M/V_{f}, where M is mass in grams and V_{f} is the tapped volume in milliliters. When Na₂SO₄ concentration in a mother solution is 1.25 mol/L, the adverse influence is limited and the particle tap density decreased from about 1.99 g/ml to about 1.98 g/ml. When the Na₂SO₄ concentration is about 2 mol/L in a mother solution, the adverse influence may become more noticeable, and the particle tap density decreased from 1.99 g/ml to 1.93 g/ml. A nickel, cobalt, manganese precursor with a particle tap density of 1.93 g/ml meets industry standards.

When the Na₂SO₄ concentration is as high as 2 mol/L in a mother solution (containing NH₄OH), Na₂SO₄ can be crystalized from the mother solution easily at room temperature. Therefore, the residual solution from the precursor synthesis herein is suitable for re-use as a mother solution for the next synthesis. In embodiments, a residual solution comprises Na₂SO₄ at a concentration of from about 0.8 mol/L to about 2 mol/L or from about 0.8 mol/L to less than about 2 mol/L.

Thus, the method according to embodiments of the disclosure facilitates the simple and efficient recovery of an alkali metal (e.g., lithium) from a waste mass, removal of impurities (e.g., copper, aluminum, iron), and recovery of transition metals (e.g., nickel, manganese, cobalt). The source of the waste mass may be any suitable or desired source, such as spent Li-ion batteries, ferromanganese slag, or mine tailings. The method according to embodiments of the disclosure may reduce one or more of time (e.g., processing time), costs (e.g., material costs), and energy (e.g., thermal energy, electrical energy, etc.) used to recycle (e.g., recover and reuse) components of the waste mass relative to conventional methods of recycling waste masses. The method of the disclosure may be more efficient, robust, and reliable than conventional methods of removing impurities and recovering metals, such as lithium, cobalt, manganese, and nickel.

The following examples serve to explain embodiments of the disclosure in more detail. These examples are not to be construed as being exhaustive or exclusive as to the scope of this disclosure.

### EXAMPLES

### Example 1

### Impurity Removal and Recovery Process

Black mass from spent lithium-ion batteries was calcinated in an N₂ atmosphere. The calcinated black mass was dissolved in an aqueous solution (first solution) (water washing) to form a dissolved waste material solution containing the calcinated black mass. Lithium carbonate (Li₂CO₃) was recovered from the dissolved waste material solution forming an initial leaching solution and solid remaining waste material containing Ni, Co, Mn, NiO, CoO, MnO, and impurities. The transition metals were leached using from about 0.1 to about 10 mol/L H₂SO₄ forming a pre-purified leaching solution converting the Ni, Co, Mn, NiO, CoO, and MnO to NiSO₄, CoSO₄, and MnSO₄. Impurities were removed from the pre-purified leaching solution by electrolysis using an electrochemical membrane reactor to form a purified leaching solution. Ammonium hydroxide (NH₄OH) and NaOH were added to the purified leaching solution to co-precipitate Ni, Mn and Co to form NiₓMn_{y}Co_{z}(OH)₂ and forming a residual solution. After precipitating out the Ni, Mn, and Co, the residual solution contained only NH₄OH, Na₂SO₄, and a low concentration of NiSO₄, MnSO₄, and CoSO₄. The Na₂SO₄ in the residual solution was reduced to less than about 1 mol 1⁻¹, by decreasing the solution temperature to about 0° C. and crystallizing Na₂SO₄ from the residual solution.

The concentration of impurities in the residual solution may affect the morphology of later synthesized NiₓMn_{y}Co_{z}(OH)₂ particles if the residual solution is reused for such synthesis. Without wishing to be bound by theory, it has been found that a residual solution with a low concentration of Na₂SO₄, such as with less than about 1 mol 1⁻¹ Na₂SO₄, can be successfully reused as a NH₄OH resource, which can be used to synthesize NiₓMn_{y}Co_{z}(OH)₂, without adversely impacting particle morphology. If lithium is not recovered before leaching the transition metal, the lithium may remain in the residual solution with a concentration as high as about 2.6 mol 1⁻¹ (lithium sulfate (Li₂SO₄ )) (having a solubility of: 34.9 g/100 mL (25° C.) and 29.2 g/100 mL (100 ° C.)). When reusing the residual solution for the co-precipitation of NiₓMn_{y}Co_{z}(OH)₂, a high concentration of Li₂SO₄ interacts with Na₂SO₄ and may adversely affect the morphology of the NiₓMn_{y}Co_{z}(OH)₂ particles. Calcinating the black mass and first removing the lithium significantly may reduce the Li₂SO₄ impurity concentration, which may affect the later co-precipitation of mixed metal oxide particles. The method enables reusing the residual solution to co-precipitate NiₓMn_{y}Co_{z}(OH)₂ particles multiple times. The method also enables recovery of Na₂SO₄ solid from the residual solution by crystallization, and then reuse of the residual solution as a mother solution for the next co-precipitation. The recovered Na₂SO₄ can be used as an electrolyte salt for the electrochemical reactor in the purifying step. Thus, the method described herein generates essentially zero waste.

Nickel manganese cobalt hydroxide (LiNiₓMn_{y}Co_{z}O)₂ can be decomposed to lithium carbonate (Li₂CO₃), nickel (Ni), manganese (Mn), cobalt (Co), nickel oxide (NiO), manganese oxide (MnO), and cobalt oxide (CoO) at about 300° C. to about 800° C. Li₂CO₃ is soluble in water (1.54 g/100 mL (0° C.); 1.43 g/100 mL (10° C.); 0.69 g/100 ml (100° C.)), and NiO, MnO and CoO can react with H₂SO₄ in the way indicated by equations (1) to (6).

NiO+H₂SO₄→NiSO₄+H₂O (1)

MnO+H₂SO₄→NiSO₄+H₂O (2)

CoO+H₂SO₄→CoSO₄+H₂O (3)

Ni+H₂SO₄→NiSO₄+H₂ (4)

Mn+H₂SO₄→MnSO₄+H₂ (5)

Co+H₂SO₄→CoSO₄+H₂ (6)

Ni_{0.8}Mn_{0.1}Co_{0.1}(OH)₂ can be synthesized for a cathode, in embodiments, for an electric vehicle battery. The reaction mechanism of synthesizing NiₓMn_{y}Co_{z}(OH)₂ precursor includes the following equations, where M denotes: Ni, Mn, and Co:

M²⁺+nNH₃→[M(NH₃)n]²⁺ (7)

X[Ni(NH₃)n]²⁺+y[Mn(NH₃)n]²⁺+z[Co(NH₃)n]²⁺+2OH₋→NiₓMn_{y}Co_{z}(OH)₂+n(x+y+z) NH₃ (8)

The transition metals coordinate to the ammonia (NH₃) first and then the metal ions are slowly released to the basic solution to yield hydroxide particles. High concentrations of cation and anion impurities may affect the coordination and hydroxide particle yielding step.

The particles can be synthesized using a jacketed reaction vessel, pH controller, and peristaltic pumps. The particles can be characterized using scanning electron microscopy, X-ray diffraction, and transmission electron microscopy, and inductively coupled plasma mass spectrometry analysis.

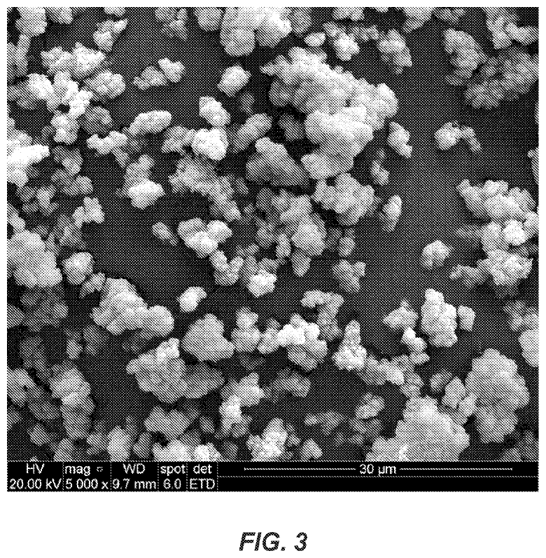

Particles synthesized from materials recovered from the present process are expected to be of industrial standard as illustrated in FIGS. 3, 4, and 5.

FIG. 3 is a scanning electron micrograph showing growth at 1 hour of industrial standard NiₓMn_{y}Co_{z}(OH)₂ particles prepared using hydrothermal synthesis.

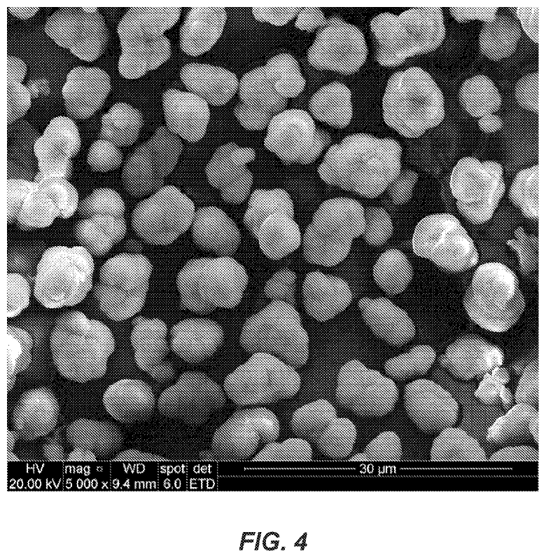

FIG. 4 is a scanning electron micrograph showing growth at 5 hours of industrial standard NiₓMn_{y}Co_{z}(OH)₂ particles prepared using hydrothermal synthesis.

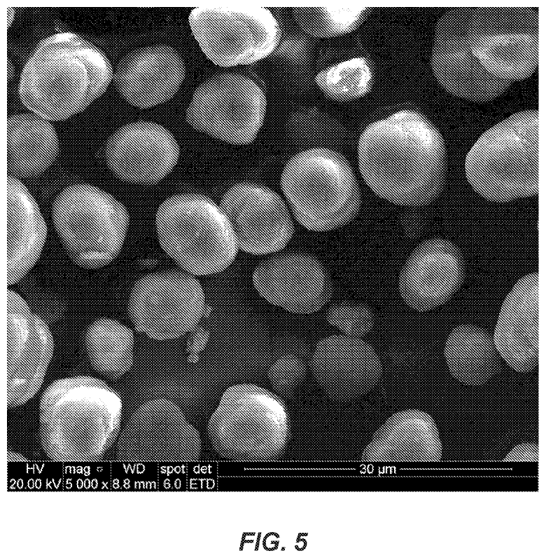

FIG. 5 is a scanning electron micrograph showing growth at 24 hours of industrial standard NiₓMn_{y}Co_{z}(OH)₂ particles prepared using hydrothermal synthesis.

### Example 2

### Comparative Example: Impurity Removal and Recovery Process

Black mass from spent lithium-ion batteries was leached with excessive H₂SO₄ acid. The pH of the leaching solution was adjusted to a pH of from about 6 to about 7 to remove impurities by adding base forming a purified leaching solution. The concentration of Ni, Co, and Mn in the purified leaching solution was adjusted by the removal of the impurities to a concentration of about 0.1 to about 2 mol 1⁻¹ Ni, about 0.1 to about 2 mol 1⁻¹ Co, and about 0.1 to about 2 mol 1⁻¹ Mn. NiₓMn_{y}Co_{z}(OH)₂ precursor was then coprecipitated in a process reactor. In this comparative example, excessive H₂SO₄ was used to leach the black mass. Excessive acid can be from about 1.9 to about 2.6 mol/L of acid in the leaching solution. The purified leaching solution, NH₄OH and NaOH, were pumped into the process reactor individually at a flow rate selected depending on the volume of the reactor. The excessive Na₂SO₄ in the hydrothermal reactor increased from 0 mol/L in the beginning to about >1 mol/L at the end of the coprecipitation process. Therefore, the residual solution included about 1.25 mol/L Na₂SO₄ with about 0.5 to about 1 mol/L NH₄OH and less than about 0.124 M Li⁺ ions. The residual solution also contained one or more of traces of Ni, Mn, and Co ions, some PO₄³⁻ ions, and organic solvent. Due to the high concentrations of impurities, the impurities would adversely affect the coprecipitation of NMC precursor. Therefore, the residual solution is unsuitable for NMC precursor precipitation and is typically discharged into the environment.

Additional non-limiting example embodiments of the disclosure are described below.

Embodiment 1: A method comprising thermally treating a solid waste material comprising carbon, at least one alkali metal, and one or more of a transition metal and a transition metal oxide, dissolving the thermally treated solid waste material in a solvent to form a dissolved waste material solution, removing the at least one alkali metal from the dissolved waste material solution to form an initial leaching solution, leaching the one or more of a transition metal and a transition metal oxide to form a pre-purified leaching solution, and removing impurities from the pre-purified leaching solution to form a purified leaching solution.

Embodiment 2: The method of Embodiment 1, further comprising precipitating particles of the transition metal from the purified leaching solution.

Embodiment 3: The method of Embodiment 1 or Embodiment 2, further comprising forming a mixed metal oxide particle comprising the recovered at least one alkali metal and the precipitated one or more transition metal and transition metal oxide particles.

Embodiment 4: The method of any of Embodiments 1-3, wherein one or more of thermally treating a solid waste material and removing the at least one alkali metal from the dissolved waste material solution comprises adjusting one or more of the dissolved waste material solution pH and temperature.

Embodiment 5: The method of any of Embodiments 1-4, wherein dissolving the thermally treated solid waste material in a solvent comprises dissolving the thermally treated solid waste material in one or more of water and weakly acidic water having a pH of from about 1 to about 6.

Embodiment 6: The method of any of Embodiments 1-5, wherein removing impurities from the pre-purified leaching solution comprises electrochemically removing impurities using an electrochemical membrane reactor.

Embodiment 7: The method of any of Embodiments 1-6, wherein leaching the one or more of the transition metal and transition metal oxide comprises adding an acid to the one or more of the transition metal and transition metal oxide, and the method further comprises recovering acid from the purified leaching solution, and reusing the recovered acid for leaching one or more of the transition metal and transition metal oxide.

Embodiment 8: The method of any of Embodiments 2-7, wherein precipitating the particles of the one or more of the transition metal and transition metal oxide from the purified leaching solution comprises adding ammonium hydroxide or sodium hydroxide to the purified leaching solution.

Embodiment 9: A method comprising calcinating black mass waste material from one or more of spent lithium ion batteries, ferromanganese slag, and mine tailings, the black mass comprising lithium and one or more of a transition metal and a transition metal oxide, dissolving the calcinated black mass in a solvent to form a dissolved waste material solution, removing lithium from the dissolved waste material solution to form an initial leaching solution, leaching the one or more of a transition metal and a transition metal oxide to form a pre-purified leaching solution, and removing impurities from the pre-purified leaching solution to form a purified leaching solution.

Embodiment 10: The method of Embodiment 9, further comprising reusing the initial leaching solution for dissolving another calcinated black mass.

Embodiment 11: The method of Embodiment 9 or Embodiment 10, further comprising precipitating the one or more of the transition metal and transition metal oxide from the purified leaching solution.

Embodiment 12: The method of any of Embodiments 9-11, wherein leaching the one or more of the transition metal and transition metal oxide comprises adding an acid to the one or more of the transition metal and transition metal oxide, precipitating the one or more of the transition metal and transition metal oxide from the purified leaching solution to form a residual solution, wherein the residual solution comprises one or more of NH₄OH, NaOH, and Na₂SO₄, and reducing a temperature of the residual solution to a temperature in a range of from about 10° C. to about −20° C., wherein the residual solution comprises a concentration of Na₂SO₄ of less than about 2 mol/L.

Embodiment 13: The method of any of Embodiments 9-12, wherein dissolving the calcinated black mass waste material in a solvent comprises dissolving the calcinated black mass in one or more of water and a weakly acidic water having a pH of from about 1 to about 6 at a temperature in the range of from about 10° C. to about −20° C.

Embodiment 14: The method of any of Embodiments 9-13, wherein removing lithium from the dissolved waste material solution comprises one or more of adjusting a pH of the dissolved waste material solution to a pH of about 2 to about 14 and increasing the temperature of the dissolved waste material solution.

Embodiment 15: The method of any of Embodiments 9-14, wherein leaching the one or more of the transition metal and transition metal oxide to form a pre-purified leaching solution comprises adding an acid to the one or more of the transition metal and transition metal oxide to convert the one or more of the transition metal and transition metal oxide to a transition metal sulfate.

Embodiment 16: The method of any of Embodiments 9-15, wherein removing impurities from the pre-purified leaching solution to form a purified leaching solution comprises removing impurities from the pre-purified leaching solution using an electrochemical membrane reactor.

Embodiment 17: The method of any of Embodiments 9-16, wherein the impurities removed from the pre-purified leaching solution comprise copper, iron, aluminum, zirconium, chromium, or a combination thereof.

Embodiment 18: The method of any of Embodiments 9-17, further comprising forming mixed metal oxide particles comprising nickel, manganese, cobalt, or a combination thereof, precipitated from the purified leaching solution, and lithium recovered from the dissolved waste material solution.

Embodiment 19: A method comprising providing a black mass from spent lithium ion batteries, the black mass comprising one or more of lithium transition metal oxide, nickel, manganese, cobalt, nickel oxide, manganese oxide, and cobalt oxide, calcinating the black mass in an inert atmosphere, the calcinated black mass comprising one or more of lithium carbonate, lithium fluoride, nickel, manganese, cobalt, nickel oxide, manganese oxide, and cobalt oxide, contacting the calcinated black mass with water to form a dissolved black mass solution, the dissolved black mass solution comprising one or more of lithium carbonate and lithium fluoride, removing one or more of the lithium carbonate and lithium fluoride from the dissolved black mass solution by adjusting one or more of the black mass solution pH and temperature to form an initial leaching solution comprising one or more of lithium carbonate and lithium fluoride, adding an acid to the one or more of nickel, manganese, cobalt, nickel oxide, manganese oxide, and cobalt oxide, to convert the one or more of nickel, manganese, cobalt, nickel oxide, manganese oxide, and cobalt oxide to nickel sulfate, manganese sulfate, and cobalt sulfate to form a pre-purified leaching solution, removing impurities from the pre-purified leaching solution to form a purified leaching solution; and adding sodium hydroxide, ammonium hydroxide, or a combination thereof to the purified leaching solution to precipitate NiₓMn_{y}Co_{z}(OH)₂ from the purified leaching solution to form a residual solution, wherein the residual solution comprises one or more of NH₄OH, NaOH, and Na₂SO₄.

Embodiment 20: The method of Embodiment 19, wherein adding an acid to the one or more of nickel, manganese, cobalt, nickel oxide, manganese oxide, and cobalt oxide, comprises adding one or more of H₂SO₄, HCL, and HNO3; and further comprising reducing the temperature of the residual solution to a temperature in a range of from about 10° C. to about −20° C., wherein the residual solution comprises a concentration of Na₂SO₄ of less than or equal to about 1 mol 1⁻¹.

The embodiments of the disclosure described above and illustrated in the accompanying drawing figures do not limit the scope of the disclosure, since these embodiments are merely examples of embodiments of the disclosure, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

1. A method comprising:
thermally treating a solid waste material comprising carbon, at least one alkali metal and one or more of a transition metal and a transition metal oxide;
dissolving the thermally treated solid waste material in a solvent to form a dissolved waste material solution;
removing the at least one alkali metal from the dissolved waste material solution to form an initial leaching solution;
leaching the one or more of the transition metal and transition metal oxide to form a pre-purified leaching solution; and
removing impurities from the pre-purified leaching solution to form a purified leaching solution.

2. The method of claim 1, further comprising:
precipitating particles of the one or more of a transition metal and a transition metal oxide from the purified leaching solution.

3. The method of claim 2, further comprising:
forming a mixed metal oxide particle comprising the recovered at least one alkali metal and the precipitated one or more transition metal and transition metal oxide particles.

4. The method of claim 1, wherein one or more of dissolving the thermally treated solid waste material and removing the at least one alkali metal from the dissolved waste material solution comprises adjusting one or more of the dissolved thermally treated solid waste material solution pH and temperature.

5. The method of claim 1, wherein dissolving the thermally treated solid waste material in a solvent comprises dissolving the thermally treated solid waste material in one or more of water and weakly acidic water having a pH of from about 1 to about 6.

6. The method of claim 1, wherein removing impurities from the pre-purified leaching solution comprises electrochemically removing impurities using an electrochemical membrane reactor.

7. The method of claim 1, wherein:
leaching the one or more of the transition metal and transition metal oxide comprises adding an acid to the one or more of the transition metal and transition metal oxide;
the method further comprising:
recovering acid from the purified leaching solution; and
reusing the recovered acid for leaching one or more of the transition metal and transition metal oxide.

8. The method of claim 2, wherein precipitating the particles of the one or more of the transition metal and transition metal oxide from the purified leaching solution comprises adding ammonium hydroxide or sodium hydroxide to the purified leaching solution.

9. A method comprising:
calcinating black mass waste material from one or more of spent lithium ion batteries, ferromanganese slag, and mine tailings, the black mass comprising lithium and one or more of a transition metal and a transition metal oxide;
dissolving the calcinated black mass in a solvent to form a dissolved waste material solution;
removing lithium from the dissolved waste material solution to form an initial leaching solution;
leaching the one or more of the transition metal and transition metal oxide to form a pre-purified leaching solution; and
removing impurities from the pre-purified leaching solution to form a purified leaching solution.

10. The method of claim 9, further comprising:
reusing the initial leaching solution for dissolving another calcinated black mass.

11. The method of claim 9, further comprising:
precipitating one or more of the transition metal and transition metal oxide from the purified leaching solution.

12. The method of claim 9, wherein:
leaching the one or more of a transition metal and a transition metal oxide comprises adding an acid to the one or more of a transition metal and a transition metal oxide;
precipitating one or more of the transition metal and transition metal oxide from the purified leaching solution to form a residual solution, wherein the residual solution comprises one or more of NH₄OH, NaOH, and Na₂SO₄; and
reducing a temperature of the residual solution to a temperature in a range of from about 10° C. to about −20° C., wherein the residual solution comprises a concentration of Na₂SO₄ of less than about 2 mol/L.

13. The method of claim 9, wherein dissolving the calcinated black mass waste material in a solvent comprises dissolving the calcinated black mass in one or more of water and weakly acidic water having a pH of from about 1 to about 6 at a temperature in a range of from about 10° C. to about −20° C.

14. The method of claim 13, wherein removing lithium from the dissolved waste material solution comprises one or more of adjusting a pH of the dissolved waste material solution to a pH of about 2 to about 14 and increasing the temperature of the dissolved waste material solution.

15. The method of claim 9, wherein leaching one or more of a transition metal and a transition metal oxide to form a pre-purified leaching solution comprises adding an acid to the one or more of a transition metal and a transition metal oxide to convert the one or more of a transition metal and a transition metal oxide to a transition metal sulfate.

16. The method of claim 9, wherein removing impurities from the pre-purified leaching solution to form a purified leaching solution comprises removing impurities from the pre-purified leaching solution using an electrochemical membrane reactor.

17. The method of claim 9, wherein:
the impurities removed from the pre-purified leaching solution comprise copper, iron, aluminum, zirconium, chromium, or a combination thereof.

18. The method of claim 9, further comprising:
forming mixed metal oxide particles comprising:
nickel, manganese, cobalt, or a combination thereof, precipitated from the purified leaching solution, and lithium recovered from the dissolved waste material solution.

19. A method comprising:
providing a black mass from spent lithium ion batteries, the black mass comprising one or more of lithium transition metal oxide, nickel, manganese, cobalt, nickel oxide, manganese oxide, and cobalt oxide;
calcinating the black mass in an inert atmosphere, the calcinated black mass comprising one or more of lithium carbonate, lithium fluoride, nickel, manganese, cobalt, nickel oxide, manganese oxide, and cobalt oxide;
contacting the calcinated black mass with water to form a dissolved black mass solution, the dissolved black mass solution comprising one or more of lithium carbonate and lithium fluoride;
removing one or more of the lithium carbonate and lithium fluoride from the dissolved black mass solution by adjusting one or more of the dissolved black mass solution pH and temperature to form an initial leaching solution comprising one or more of lithium carbonate and lithium fluoride;
adding an acid to the one or more of nickel, manganese, cobalt, nickel oxide, manganese oxide, and cobalt oxide, to convert the one or more of nickel, manganese, cobalt, nickel oxide, manganese oxide, and cobalt oxide to nickel sulfate, manganese sulfate, and cobalt sulfate to form a pre-purified leaching solution;
removing impurities from the pre-purified leaching solution to form a purified leaching solution; and
adding sodium hydroxide, ammonium hydroxide, or a combination thereof to the purified leaching solution to precipitate NiₓMn_{y}Co_{z}(OH)₂ from the purified leaching solution to form a residual solution, wherein the residual solution comprises one or more of NH₄OH, NaOH, and Na₂SO₄.

20. The method of claim 19, wherein adding an acid to the one or more of nickel, manganese, cobalt, nickel oxide, manganese oxide, and cobalt oxide comprises adding one or more of H₂SO₄, HCl, and HNO₃; and further comprising:
reducing the temperature of the residual solution to a temperature in a range of from about 10° C. to about −20° C., wherein the residual solution comprises a concentration of Na₂SO₄ of less than or equal to about 1 mol 1⁻¹.
